(19) United States
(12) Patent Application Publication
(10) Pub. No.: US 2006/0169119 A1
(43) Pub. Date: Aug. 3, 2006

(54) Quick adjusting device for a lower guide base of a band saw

(75) Inventor: Richard Chang, Fang Yuan City (TW)

Correspondence Address: TROXELL LAW OFFICE PLLC, SUITE 1404, 5205 LEESBURG PIKE, FALLS CHURCH, VA, 22041, US

(73) Assignee: Kingsand Machinery Ltd.

(21) Appl. No.: 11/044,073

(22) Filed: Jan. 28, 2005

(51) Int. Cl. B23D 53/00

(52) U.S. Cl. 83/820

(57) ABSTRACT

A quick adjusting device for a lower guide base of a band saw includes a base plate, an adjusting base, a guide unit, a tightening member and an adjusting rod. The base plate is connected firmly with a lower guide base of a band saw to move altogether, having a transverse guide slot for the tightening member to pass through and then screw with a worktable. The adjusting base is fixed on the work table, having one side combined with the guide unit and the other side combined with the threaded rod, for the guide unit to fit in the base plate and for the adjusting rod to engage with. Then the base plate and the lower guide base can be moved to adjust their locations to suit to band saw bodies with various widths, by rotating the adjusting rod and moving said guide unit.

### BACKGROUND OF THE INVENTION

1. Field of the Invention

This invention relates to a band saw, particularly to a quick adjusting device for a lower guide base of a band saw so as to easily and quickly adjust the location of the lower guide base for changing a band saw body.

2. Description of the Prior Art

A conventional band saw generally has a lower guide base, which consists of a stationary base fixed on a work table, and a saw back leaning member and a saw surface guiding member. The saw back leaning member is fixed on top of the stationary base for urging and guiding the rear edge of the band saw body and the saw surface guiding member is fixed at the front end of the stationary base for sandwiching the two surfaces of the band saw body. Then in case of changing band saw bodies of different width, a user has to adjust the saw back leaning member and the saw body sandwiching member for correctly guiding a new band saw body in moving.

However, the saw back leaning member is located below the worktable, a user cannot directly adjust it before the worktable is taken off, very inconvenient to handle.

### SUMMARY OF THE INVENTION

The quick adjusting device for a lower guide base of a band saw in the present invention is composed of a base plate, a tightening member, an adjusting base, a guide unit and an adjusting rod. The base plate is connected firmly with the lower guide base of a band saw, moving the lower guide base together, having a transverse guide slot for the tightening rod to pass through and then screwing with a work table tightly or loosely. The adjusting base is fixed on the work table, having two sides respectively combined with the guide unit to fit in and for the adjusting rod to engage so that the base plate and the lower guide base may be shifted by rotating the threaded rod and guided movement of the guide unit.

The device in the invention can let the threading rod rotated for adjusting the locations of the base plate together with the lower guide base to suit to band saws with various width, without necessity of taking off the lower guide base as required in a conventional band saw, very convenient for replacing a band saw with different width.

### BRIED DESCRIPTION OF DRAWINGS

This invention will be better understood by referring to the accompanying drawings, wherein:

FIG. 1 is a perspective view of a band saw having a quick adjusting device for a lower guide base in the present invention;

FIG. 2 is a perspective view of the quick adjusting device and the lower guide base in the present invention;

FIG. 3 is an exploded perspective view of the quick adjusting device and the lower guide base in the present invention;

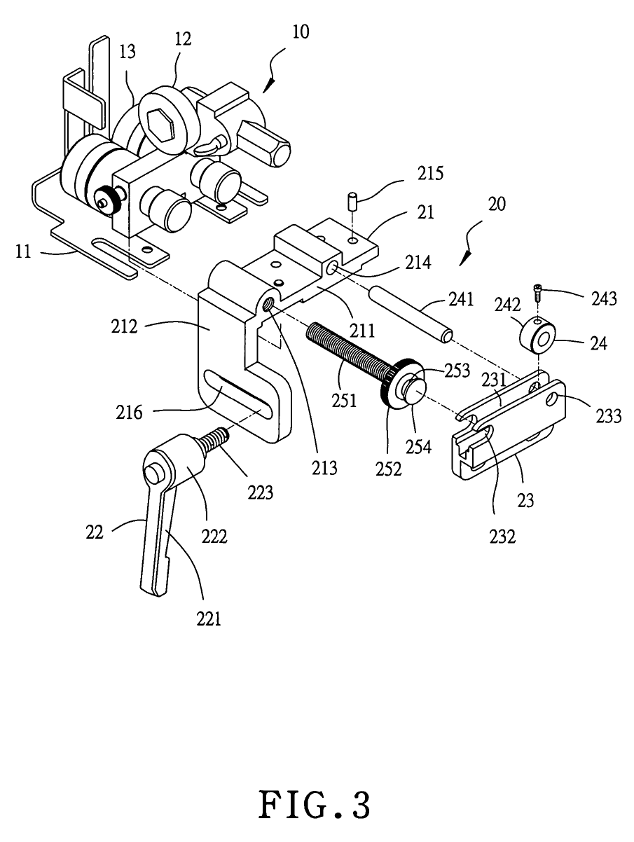

FIG. 4 is a side cross-sectional view of the quick adjusting device and the lower guide base in the present invention; and,

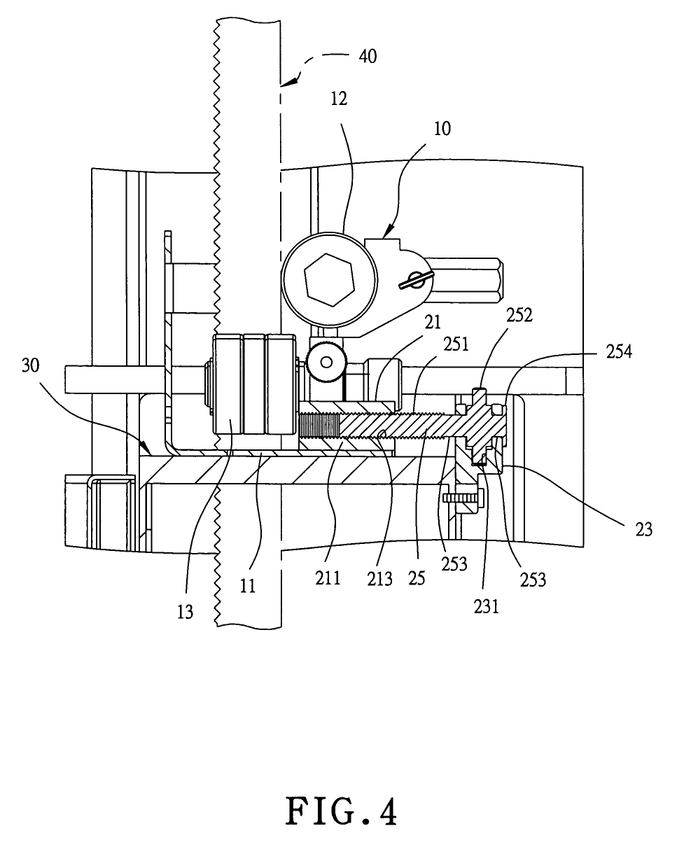

FIG. 5 is the side cross-sectional view of the quick adjusting device being adjusted in the present invention.

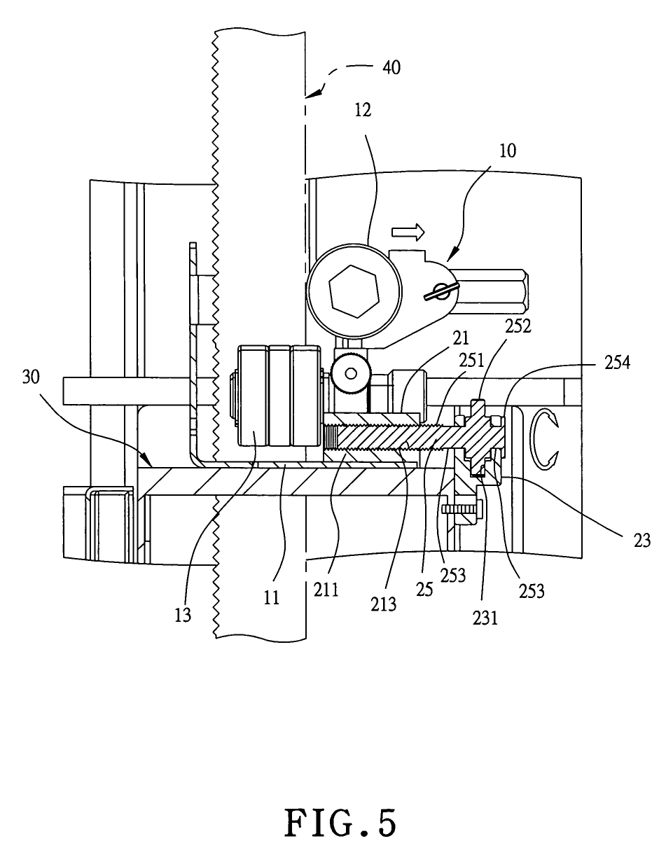

### DETAILED DESCRIPTION OF THE PREFERRED EMBODIMENT

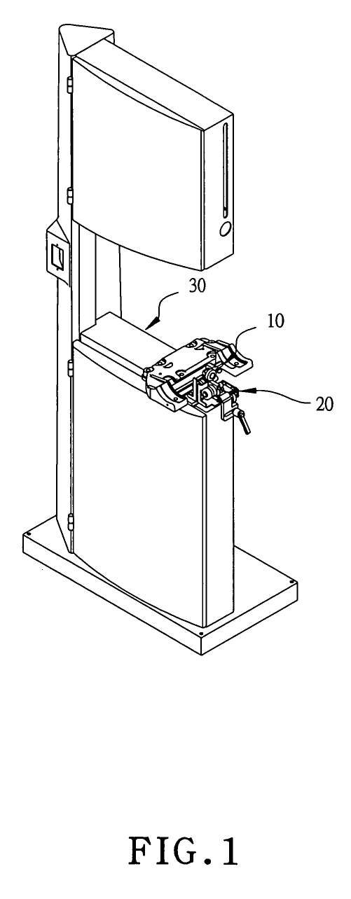

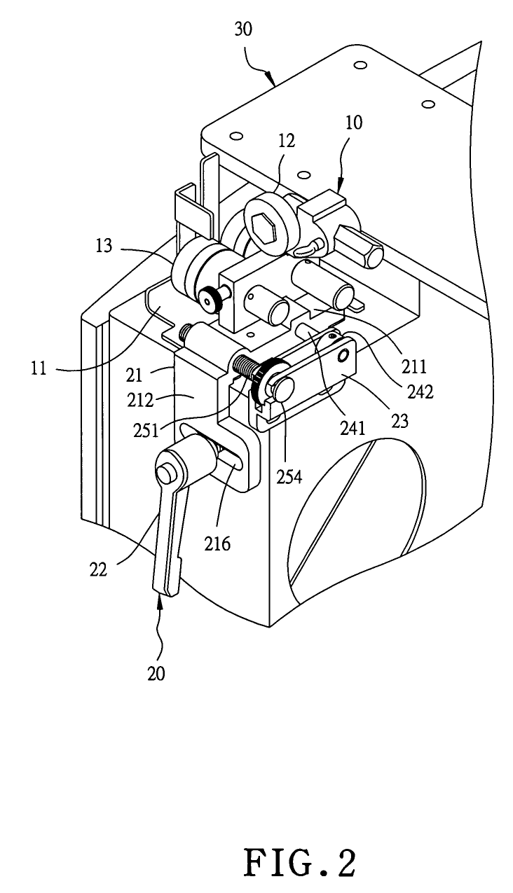

A preferred embodiment of a quick adjusting device for a lower guide base of a band saw in the present invention, as shown in FIGS. 1 and 2, is combined with a lower guide base 10, which has a structure almost the same as that used in a conventional band saw. The lower guide base 10 consists of a stationary base 11, a saw back leaning member 12 and a saw surface guiding member 13. The saw back leaning member 12 urges and guides the rear edge of the band saw body, and the saw surface guiding member 13 sandwiches the two surfaces of the saw body.

The quick adjusting device 20 includes a base plate 21, a tightening member 22, an adjusting base 23, a guide member 24 and an adjusting rod 25.

The base plate 21 is shaped as L, having a horizontal plate 211 and a vertical side plate 212 extending down from one side of the horizontal plate 211, which is provided with a lateral threaded hole 213 and a lateral guide hole 214 spaced apart on its surface, and a plurality of pin holes for position pins 215 to fit through and in the stationary base 11 of the lower guide base 10 for combining the base plate 21 with the lower guide base 10. Then the lower guide base 10 can move together with the base plate 21. The vertical side plate 212 is provided with a transverse guide slot 216.

The tightening member 22 is a handle in this embodiment, consisting of a handle member 221 and a head member 222. The head member 222 further has a screw member 223 extending outward, to pass first through the guide slot 216 and then screw with the wall of the table 30 so as to tighten and loosen the base plate 21.

The adjusting base 23 is fixed firmly on a sidewall of the table 30, provided with a gap 231 defined by two parallel walls in its top, and a limit groove 232 respectively formed in one end of the parallel walls and a hole 233 respectively near the other end of the two parallel walls.

The guide unit 24 consists of a guide bar 241 with one end extending in the guide hole 214 of the base plate 21 and the other end extending through the holes 233 of the adjusting base 23, and a ring 242 fitted in the gap 231. Then a screw 243 screws sidewise with the ring 242 and also presses the guide bar 241 extending through the ring 242 to keep the guide bar 241 tightly immovable so as to guide the base plate 21.

The adjusting rod 25 is provided with a threaded rod portion 251 in one end to engage with the threaded hole 213 of the base plate 21 and a ring-shaped member 252 of a large diameter, and a collar 253 of a small diameter respectively formed at two sides of the ring-shaped member 252, and a stop member 254 extending from the ring-shaped member 252 and larger than the collars 253 so that the ring shaped member 252 may move and fit in the gap 231 of the adjusting base 23 horizontally, with the two collars 253 may move horizontally and fit in the limit grooves 232 and be stopped in place by the stop member 254 and the relative wall of the adjusting base 23. Then the adjusting rod 25 is kept in the limit position on the adjusting base 23, and the ring shaped member 252 is rotated to rotate the adjusting rod 25 for linearly moving the base plate 21 to suit to the width of the band saw body 40.

Next, in replacing an old band saw body 40 with a new one having a different size, as the rear edge of the new saw body 40 may be located not the same as the old one, in other words, the surface of the new saw body 40 is wider or narrower than the old one, the saw back leaning member 12 has to be shifted in its location to suit to the rear edge of the new saw body, by loosening the tightening member 22 and rotating the adjusting rod 252 to move linearly the base plate 21 together with the lower guide base 10 in the width direction of the saw body 40, letting the saw back leaning member 12 to urge and guide the rear edge of the new saw body 40. Then the tightening member 22 is rotated tightly again against the base plate 21 to finish the adjusting process.

It is necessary to mention that in this invention the work table (not shown) is not needed to be taken off in replacing an old saw body with a new one, only loosening and tightening of the tightening member 22 and rotation of the adjusting rod 25 is enough for the work, very effective.

While the preferred embodiment of the invention has been described above, it will be recognized and understood that various modifications may be made therein and the appended claims are intended to cover all such modifications that may fall within the spirit and scope of the invention.

What is claimed is:

1. A quick adjusting device for a lower guide base of a band saw, said device comprising:
A base plate combined tightly with a lower guide base on a work table of a band saw for moving said lower guide base together, said base plate having a transverse guide slot at a preset location for the width of a band saw body:
A tightening member fitting through said guide slot of said base plate and engaging with a sidewall of said work table for tightening and loosening said base plate:
An adjusting base fixed properly on said worktable, having two parallel walls defining a gap between them, said two parallel walls provided respectively with a hole facing each other:
A guide unit consisting of a guide bar, a ring fitted in said gap of said adjusting base, said guiding bar having one end extending in said guide hole of said base plate and the other end extending in said two holes of said adjusting base and further passing through said ring so that said guide bar may be fixed with said adjusting base for guiding said base plate to be shifted in its location:
An adjusting rod having a threaded rod portion in one end to engage with said base plate and the other end provided with a ring-shaped member of a large diameter, said ring-shaped member rotating in said gap of said adjusting base, said ring-shaped member moving said base plate and said lower guide base at the same time so as to suit to a band saw body with various width if a user rotates said ring-shaped member for adjusting said adjusting rod.

2. The quick adjusting device for a lower guide base of a band saw as claimed in claim 1, wherein said base plate is combined with said lower guide base by means of position pins.

3. The quick adjusting device for a lower guide base of a band saw as claimed in claim 1, wherein said tightening member is a handle having a head end and a screw member extending out from said head end, said screw extending through said transverse guide slot of said base plate and further screwing tightly or loosely with a sidewall of said work table.

4. The quick adjusting device for a lower guide base of a band saw as claimed in claim 1, wherein said base plate has a horizontal plate and a vertical side plate extending down from one end of said horizontal plate and bored with a transverse guide slot, said horizontal plate having a lateral threaded hole and a lateral guide hole spaced apart on its surface, said threaded hole engaging with said threaded rod, said guide hole fitted with said guide bar of said guide unit.

5. The quick adjusting device for a lower guide base of a band saw as claimed in claim 1, wherein said two parallel walls of aid adjusting base have respectively a limit groove formed in one end, said adjusting rod has a collar of a small diameter formed at two sides of said ring-shaped member, a stop member of a larger diameter than that of said collars, said two collars possible to move in said two limit grooves horizontally, said stop member contacting said sidewall of said adjusting base to limit said adjusting rod in said adjusting base axially.

6. The quick adjusting device for a lower guide base of a band saw as claimed in claim 1, wherein said guide bar fitting through said ring of said guide unit is firmly stopped by a screw screwing through said ring.
